(19) United States
(12) Patent Application Publication
(10) Pub. No.: US 2010/0081061 A1
(43) Pub. Date: Apr. 1, 2010

(54) ELECTROLYTIC SOLUTION AND BATTERY

(75) Inventors: Akira Ichihashi, Fukushima (JP); Gentaro Kano, Fukushima (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 11/815,945

(22) PCT Filed: Feb. 14, 2006
(86) PCT No.: PCT/JP2006/302489

§ 371 Date: Sep. 15, 2009

(30) Foreign Application Priority Data
Feb. 17, 2005 (JP) 2005-040789

(51) Int. Cl. H01M 6/16

(52) U.S. Cl. 429/338

(57) ABSTRACT

An electrolytic solution capable of suppressing the decomposition reaction of the solvent and a battery using it are provided. A cathode (21) and an anode (22) are layered with an electrolyte layer (24) in between. The electrolyte layer (24) includes a gelatinous electrolyte, containing the electrolytic solution and a polymer compound. The electrolytic solution contains vinylene carbonate and a γ-butyrolactone derivative in which an aryl group is bonded to γ position. Thereby, the decomposition reaction of the solvent is suppressed, and thus while the battery is prevented from being swollen, the initial efficiency is improved.

### TECHNICAL FIELD

The present invention relates to an electrolytic solution containing vinylene carbonate and a battery using the electrolytic solution.

### BACKGROUND ART

In recent years, downsizing and weight saving of portable electronic devices typified by a mobile phone, a PDA (personal digital assistant), and a notebook personal computer have been actively promoted. As part thereof, the energy density of batteries, in particular the secondary batteries as the driving power source thereof has been strongly aspired. As a secondary battery capable of providing a high energy density, for example, lithium ion secondary batteries using a material capable of inserting and extracting lithium (Li) such as a carbon material for the anode are known.

Further, in recent years, as a secondary battery capable of providing a high energy density, a secondary battery in which a material capable of inserting and extracting lithium is used for the anode and the capacity of the anode includes the capacity component due to insertion and extraction of lithium and the capacity component due to precipitation and dissolution of lithium by precipitating a lithium metal on the surface has been developed (for example, refer to Patent document 1).

In these secondary batteries, in the past, it has been considered to mix an additive such as vinylene carbonate in the electrolyte to improve the battery characteristics such as the cycle characteristics (for example, refer to Patent document 2).

Patent document 1: International Publication No. 01/22519
Patent document 2: Japanese Unexamined Patent Publication No. 2003-197259

### DISCLOSURE OF THE INVENTION

It is considered that vinylene carbonate suppresses decomposition reaction of the solvent by forming a stable coating film on the electrode surface in the initial charge and discharge. However, there has been a problem that when a substance having the reaction potential (reduction potential) close to that of vinylene carbonate, for example, propylene carbonate is contained in the electrolytic solution, the decomposition reaction of propylene carbonate is not sufficiently suppressed due to the speed factor, and thus the initial efficiency is lowered.

Further, vinylene carbonate has low stability on the oxidation side. Therefore, there has been a problem that, for example, in the case that a film exterior member is used, vinylene carbonate is decomposed when a battery is charged and stored at a high temperature, and the battery is swollen.

In view of the foregoing problems, it is an object of the invention to provide an electrolytic solution capable of suppressing decomposition reaction of the solvent, and a battery using the electrolytic solution.

An electrolytic solution according to the invention contains vinylene carbonate and a γ-butyrolactone derivative in which an aryl group is bonded to γ position.

A battery according to the invention includes a cathode, an anode, and an electrolytic solution. The electrolytic solution contains vinylene carbonate and a γ-butyrolactone derivative in which an aryl group is bonded to γ position.

The electrolytic solution of the invention contains the vinylene carbonate and the γ-butyrolactone derivative in which an aryl group is bonded to γ position. Therefore, the decomposition reaction of the solvent can be suppressed. Consequently, according to the battery of the invention using the electrolytic solution, while the battery is prevented from being swollen, the initial efficiency can be improved.

In particular, when the content of the vinylene carbonate in the electrolytic solution is 0.5 wt % or more, or the content of the γ-butyrolactone derivative in the electrolytic solution is in the range from 0.1 wt % or more to 2 wt % or less, higher effects can be obtained.

### BRIEF DESCRIPTION OF THE DRAWINGS

FIG. 1 is an exploded perspective view showing a structure of a secondary battery according to an embodiment of the invention; and

FIG. 2 is a cross section showing a structure taken along line II-II of a spirally wound electrode body shown in FIG. 1.

### BEST MODE FOR CARRYING OUT THE INVENTION

Embodiments of the invention will be hereinafter described in detail with reference to the drawings.

### First Embodiment

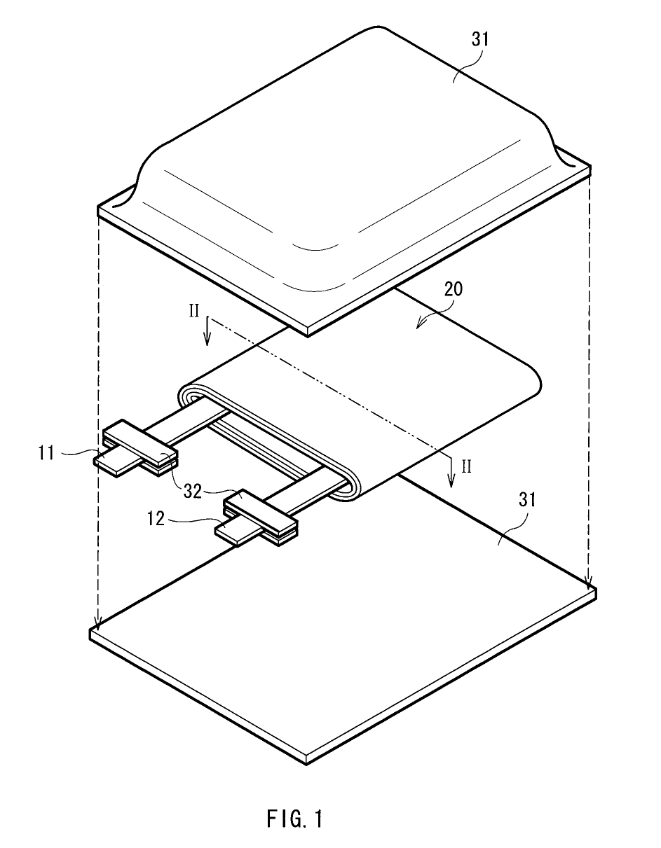

FIG. 1 shows an example of an exploded structure of a secondary battery according to a first embodiment of the invention. The secondary battery is a so-called lithium ion secondary battery in which the capacity of the anode is expressed by a capacity component due to insertion and extraction of lithium as an electrode reactant. The secondary battery has a structure in which a spirally wound electrode body 20 to which a cathode lead 11 and an anode lead 12 are attached is contained in a film package member 31.

The cathode lead 11 and the anode lead 12 are, for example, in the shape of a strip, respectively, and are respectively directed from inside to outside of the package member 31 in the same direction, for example. The cathode lead 11 is made of, for example, a metal material such as aluminum (Al). The anode lead 12 is made of, for example, a metal material such as nickel (Ni).

The package member 31 is made of a rectangular laminated film in which, for example, a nylon film, an aluminum foil, and a polypropylene film are bonded together in this order. The package member 31 is, for example, arranged so that the polypropylene film side faces the spirally wound electrode body 20, and the respective outer edges are contacted to each other by fusion bonding or an adhesive.

Adhesive films 32 to improve contact characteristics between the cathode lead 11/the anode lead 12 and inside of the package member 31 and to protect from entering of outside air are inserted between the package member 31 and the cathode lead 11/the anode lead 12. The adhesive film 32 is made of a material having contact characteristics to the cathode lead 11 and the anode lead 12. For example, the adhesive film 32 is preferably made of a polyolefin resin such as polyethylene, polypropylene, modified polyethylene, and modified polypropylene when the cathode lead 11 and the anode lead 12 are made of the foregoing metal material.

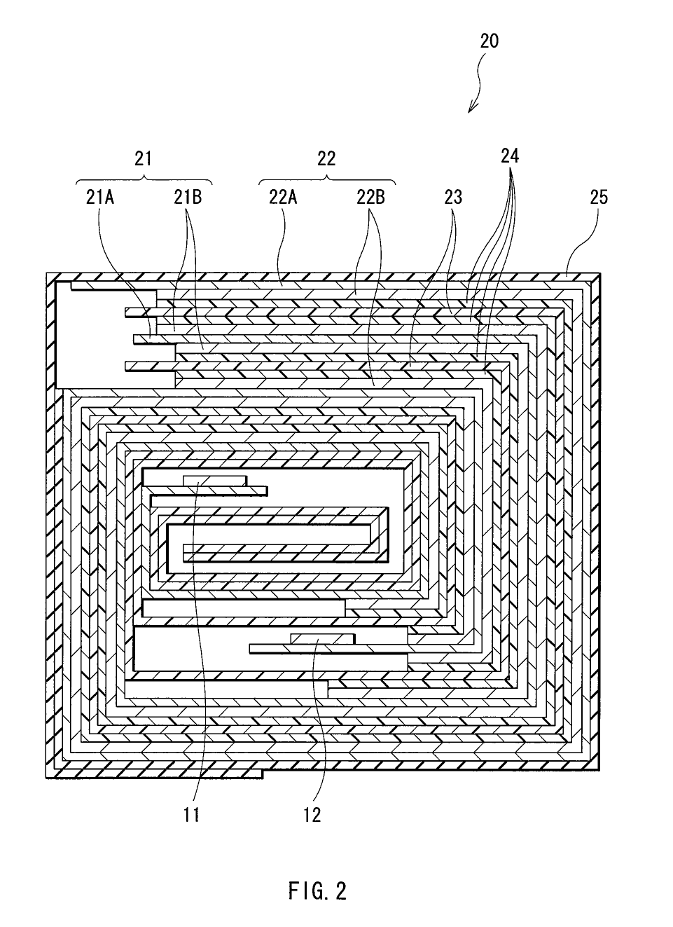

FIG. 2 shows a cross sectional structure taken along line II-II of the spirally wound electrode body 20 shown in FIG. 1. In the spirally wound electrode body 20, a cathode 21 and an anode 22 are layered with a separator 23 and an electrolyte layer 24 in between and spirally wound. The outermost periphery of the spirally wound electrode body 20 is protected by a protective tape 25.

The cathode 21 has, for example, a cathode current collector 21A and a cathode active material layer 21B provided on the both faces or a single face of the cathode current collector 21A. In the cathode current collector 21A, for example, there is an exposed portion provided with no cathode active material layer 21B on one end thereof in the longitudinal direction. The cathode lead 11 is attached to the exposed portion. The cathode current collector 21A is made of a metal material such as aluminum.

The cathode active material layer 21B contains, for example, as a cathode active material, one or more cathode materials capable of inserting and extracting lithium as an electrode reactant. As the cathode material capable of inserting and extracting lithium, for example, a lithium-containing compound such as a lithium oxide, a lithium phosphorous oxide, a lithium nitride, and an intercalation compound containing lithium is appropriate. Two or more thereof may be used by mixing. In particular, to improve the energy density, the lithium complex oxide or the lithium phosphorous oxide expressed by general formula of LiₓMIO₂ or Li_{y}MIIPO₄ is preferable. In the formula, MI and MII represent one or more transition metals, and preferably represent at least one of cobalt (Co), nickel, manganese (Mn), iron (Fe), aluminum, vanadium (V), titanium (Ti), and zirconium (Zr). Values of x and y vary according to charge and discharge state of the battery, and are generally in the range of 0.05≦x≦1.10 and 0.05≦y≦1.10. As a specific example of the lithium complex oxide expressed by LiₓMIO₂, for example, LiCoO₂, LiNiO₂, LiNi_{0.5}Co_{0.5}O₂, LiNi_{0.5}Cu_{0.2}Mn_{0.3}O₂, LiMn₂O₄ having a spinel type crystal structure or the like can be cited. As a specific example of the lithium phosphorous oxide expressed by Li_{y}MIIPO₄, for example, LiFePO₄, LiFe_{0.5}Mn_{0.5}PO₄ and the like can be cited.

The cathode active material layer 21B contains, for example, an electrical conductor, and may contain a binder if necessary. As an electrical conductor, for example, a carbon material such as graphite, carbon black, and Ketjen black can be cited. One thereof may be used singly, or two or more thereof may be used by mixing. In addition to the carbon material, a metal material, a conductive polymer material or the like may be used, as long as such a material has conductivity. As a binder, for example, synthetic rubber such as styrene-butadiene rubber, fluorinated rubber, and ethylene propylene diene rubber; or a polymer material such as polyvinylidene fluoride can be cited. One thereof may be used singly, or two or more thereof may be used by mixing.

The anode 22 has an anode current collector 22A and an anode active material layer 22B provided on the both faces or a single face of the anode current collector 22A similarly to the cathode 21. In the anode current collector 22A, for example, there is an exposed portion provided with no anode active material layer 22B on one end thereof in the longitudinal direction. The anode lead 12 is attached to the exposed portion. The anode current collector 22A is made of, for example, a metal material such as copper (Cu).

The anode active material layer 22B contains, for example, as an anode active material, one or more anode materials capable of inserting and extracting lithium as an electrode reactant. If necessary, the anode active material layer 22B may contain a binder similar to that of the cathode active material layer 21B, for example.

As an anode material capable of inserting and extracting lithium, for example, a carbon material such as graphite, non-graphitizable carbon, and graphitizable carbon can be cited. The carbon material is preferably used, since the crystal structure generated in charge and discharge is very little, a high charge and discharge capacity can be obtained, and favorable charge and discharge cycle characteristics can be obtained. In particular, graphite is preferable, since the discharge capacity is high and thereby a high energy density can be obtained.

As an anode material capable of inserting and extracting lithium, a material that can insert and extract lithium and contains at least one of a metal element and a metalloid element as an element can be mixed in addition to the foregoing carbon material, since thereby a high energy density can be obtained. Such an anode material may be a simple substance, an alloy, or a compound of the metal element; a simple substance, an alloy, or a compound of the metalloid element; or a material having one or more phases thereof at least in part. In the invention, the alloy includes an alloy containing one or more metal elements and one or more metalloid elements, in addition to an alloy including two or more metal elements. Further, the alloy may contain a nonmetal element. The texture thereof may be a solid solution, a eutectic crystal (eutectic), an intermetallic compound, or a texture in which two or more thereof coexist.

As the metal element or the metalloid element that composes the anode material, for example, magnesium (Mg), boron (B), aluminum, gallium (Ga), indium (In), silicon (Si), germanium (Ge), tin (Sn), lead (Pb), bismuth (Bi), cadmium (Cd), silver (Ag), zinc (Zn), hafnium (Hf), zirconium, yttrium (Y), palladium (Pd), or platinum (Pt) that can form an alloy with lithium can be cited. Such an element can be crystalline or amorphous.

Specially, an anode material containing a metal element or a metalloid element of Group 4B in the short period periodic table as an element is preferable. An anode material containing at least one of silicon and tin as an element is particularly preferable. Silicon and tin have a high ability to insert and extract lithium, and can provide a high energy density.

As an alloy of tin, for example, an alloy containing at least one selected from the group consisting of silicon, nickel, copper, iron, cobalt, manganese, zinc, indium, silver, titanium, germanium, bismuth, antimony (Sb), and chromium (Cr) as a second element other than tin can be cited. As an alloy of silicon, for example, an alloy containing at least one selected from the group consisting of tin, nickel, copper, iron, cobalt, manganese, zinc, indium, silver, titanium, germanium, bismuth, antimony, and chromium as a second element other than silicon can be cited.

As a compound of tin or a compound of silicon, for example, a compound containing oxygen (O) or carbon (C) can be cited. In addition to tin or silicon, the compound may contain the foregoing second element.

As an anode material capable of inserting and extracting lithium, other metal compound or a polymer material may be mixed in addition to the foregoing carbon material. As other metal compound, an oxide such as iron oxide, ruthenium oxide, and molybdenum oxide, Li₃N or the like can be cited. As a polymer material, polyacetylene or the like can be cited.

In the secondary battery, the capacity of the anode material capable of inserting and extracting lithium is larger than the capacity of the cathode 21. Therefore, lithium metal is not precipitated on the anode 22 during the charge.

The separator 23 is made of, for example, a synthetic resin porous film made of polytetrafluoroethylene, polypropylene, and polyethylene, or a ceramic porous film. The separator 23 may have a structure in which two or more porous films as the foregoing porous films are layered. Specially, a porous film made of polyolefin is preferable, since such a porous film has superior short circuit prevention effect, and improves battery safety by shutdown effect. In particular, polyethylene is preferable as a material of the separator 23, since polyethylene can provide shutdown effect in the range from 100 deg C. to 160 deg C., and has superior electrochemical stability. Further, polypropylene is also preferable. In addition, any other resin having chemical stability can be used by being copolymerized with polyethylene or polypropylene, or being blended therewith.

The electrolyte layer 24 is a so-called gelatinous electrolyte, containing an electrolytic solution and a polymer compound holding the electrolytic solution. The electrolytic solution contains, for example, a nonaqueous solvent and an electrolyte salt dissolved in the nonaqueous solvent.

As a nonaqueous solvent, for example, ethylene carbonate, propylene carbonate, dimethyl carbonate, ethyl methyl carbonate, diethyl carbonate, 1,2-dimethoxyethane, 1,2-diethoxyethane, γ-butyrolactone, γ-valerolactone, tetrahydrofuran, 2-methyltetrahydrofuran, 1,3-dioxolan, 4-methyl-1,3-dioxolan, diethyl ether, sulfolane, methyl sulfolane, acetonitrile, propionitrile, anisole, ester acetate, ester butyrate, ester propionate, fluoro benzene or the like can be cited. The solvent may be used singly, or two or more thereof may be used by mixing.

As an electrolyte salt, for example, a lithium salt such as LiAsF₆, LiPF₆, LiBF₄, LiClO₄, LiB(C₆H₅)₄, LiCH₃SO₃, LiCF₃SO₃, LiN(CF₃SO_{2,})₂, LiN(C₂F₅SO_{2,})₂, LiC(CF₃SO_{2,})₃, LiAlCl₄, Li₂SiF₆, LiCl, and LiBr can be cited. One of the electrolyte salts may be used singly, or two or more thereof may be used by mixing them.

The content of the electrolyte salt is preferably in the range from 0.5 mol/kg to 3.0 mol/kg to the solvent. When the content is out of the range, the ion conductivity is largely lowered, and thus there is a possibility that sufficient battery characteristics are not able to be obtained.

The electrolytic solution further contains vinylene carbonate and a γ-butyrolactone derivative in which an aryl group is bonded to γ position. When the γ-butyrolactone derivative is contained in addition to vinylene carbonate, a coating film is formed on the surface of the anode 22 at the anode potential nobler than the potential in the case of using only vinylene carbonate. In addition, the film becomes denser, and thus lowering of the initial efficiency due to decomposition reaction of the solvent can be more suppressed. Further, even when the charged battery is stored at a high temperature, the battery can be prevented from being swollen due to decomposition reaction of the solvent. Vinylene carbonate or a γ-butyrolactone derivative that is left without contributing to the formation of the coating film also functions as a solvent.

As a γ-butyrolactone derivative, for example, γ-phenyl-γ-butyrolactone or γ-naphthyl-γ-butyrolactone can be cited. One of γ-butyrolactone derivatives may be used, or two or more thereof may be used.

The content of vinylene carbonate in the electrolytic solution is preferably 0.5 wt % or more. The content of the γ-butyrolactone derivative in the electrolytic solution is preferably in the range from 0.1 wt % or more to 2 wt % or less. In such a range, higher effects can be obtained.

Any polymer compound may be used as long as the polymer compound absorbs and gelates the solvent. For example, a fluorinated polymer compound such as polyvinylidene fluoride and a copolymer of vinylidene fluoride and hexafluoropropylene, an ether polymer compound such as polyethylene oxide and a cross-linked body containing polyethylene oxide, a compound including polyacrylonitrile, polyacrylate, or polymethacrylate as a repeating unit or the like can be cited. In particular, in terms of redox stability, the fluorinated polymer compound is desirable. One of the polymer compounds may be used singly, or two or more thereof may be used by mixing.

The secondary battery can be manufactured, for example, as follows.

First, for example, a cathode active material, a binder, and an electrical conductor are mixed to prepare a cathode mixture. The cathode mixture is dispersed in a solvent such as N-methyl-2-pyrrolidone to form cathode mixture slurry. Next, the both faces of the cathode current collector 21A or a single face thereof is coated with the cathode mixture slurry, dried, and the resultant is compression-molded. Consequently, the cathode active material layer 21B is formed and the cathode 21 is formed. Subsequently, for example, the cathode lead 11 is attached to the cathode current collector 21A by, for example, ultrasonic welding or spot welding. After that, the electrolyte layer 24 is formed on the cathode active material layer 21B, that is, the both faces of the cathode 21 or the single face thereof.

Further, for example, an anode active material and a binder are mixed to prepare an anode mixture. The anode mixture is dispersed in a solvent such as N-methyl-2-pyrrolidone to form anode mixture slurry. Next, the both faces of the anode current collector 22A or a single face thereof is coated with the anode mixture slurry and dried. Then, the resultant is compression-molded. Consequently, the anode active material layer 22B is formed and the anode 22 is formed. Subsequently, the anode lead 12 is attached to the anode current collector 22A by, for example, ultrasonic welding or spot welding. The electrolyte layer 24 is formed on the anode active material layer 22B, that is, on the both faces of the anode 22 or the single face thereof in the same manner as in the cathode 21.

After that, the cathode 21 and the anode 22 both formed with the electrolyte layer 24 are layered with the separator 23 in between and are spirally wound. The protective tape 25 is adhered to the outermost periphery to form the spirally wound electrode body 20. Finally, for example, the spirally wound electrode body 20 is sandwiched between the package members 31, and the outer peripheral edges of the package members 31 are hermetically sealed by thermal fusion bonding or the like, and the spirally wound electrode body 20 is enclosed. At this time, the adhesive films 32 are inserted between the cathode lead 11/anode lead 12 and the package member 31. Thereby, the secondary battery shown in FIGS. 1 and 2 is completed.

Further, the foregoing secondary battery may be fabricated as follows. First, the cathode 21 and the anode 22 are formed as described above, and the cathode lead 11 and the anode 12 are attached to the cathode 21 and the anode 22. After that, the cathode 21 and the anode 22 are layered with the separator 23 in between and are spirally wound. The protective tape 25 is adhered to the outermost periphery thereof, and a spirally wound electrode body is formed. Next, the spirally wound electrode body is sandwiched between the package members 31, the outermost peripheries except for one side are thermally fusion-bonded to obtain a pouched state, and the spirally wound electrode body is contained inside the package member 31. Subsequently, a composition of matter for electrolyte containing an electrolytic solution, a monomer as a raw material for the polymer compound, a polymerization initiator, and if necessary other material such as a polymerization inhibitor is prepared, which is injected into the package member 31.

After the composition of matter for electrolyte is injected, the opening of the package member 31 is thermally fusion-bonded and hermetically sealed in the vacuum atmosphere. Next, the resultant is heated to polymerize the monomer to obtain a polymer compound. Thereby, the gelatinous electrolyte layer 24 is formed, and the secondary battery shown in FIGS. 1 and 2 is assembled.

In the secondary battery, when charged, for example, lithium ions are extracted from the cathode 21 and inserted in the anode 22 through the electrolytic solution. When discharged, for example, the lithium ions are extracted from the anode 22, and inserted in the cathode 21 through the electrolytic solution. In this embodiment, the electrolytic solution contains vinylene carbonate and a γ-butyrolactone derivative in which an aryl group is bonded to γ position. Therefore, the decomposition reaction of the solvent is suppressed.

As described above, according to the secondary battery of this embodiment, the electrolytic solution contains the vinylene carbonate and the γ-butyrolactone derivative in which an aryl group is bonded to γ position. Therefore, the decomposition reaction of the solvent can be suppressed, and thus while the battery is prevented from being swollen, the initial efficiency can be improved.

In particular, when the content of vinylene carbonate in the electrolytic solution is 0.5 wt % or more, or the content of γ-butyrolactone derivative in the electrolytic solution is in the range from 0.1 wt % or more to 2 wt % or less, higher effects can be obtained.

### Second Embodiment

A secondary battery according to a second embodiment of the invention is a secondary battery in which the anode capacity includes the capacity component due to insertion and extraction of lithium as an electrode reactant and the capacity component due to precipitation and dissolution of lithium, and is expressed by the sum thereof.

The secondary battery has a structure and effects similar to those of the secondary battery according to the first embodiment, except that the structure of the anode active material layer is different, and can be similarly manufactured. Therefore, here, descriptions will be given by using the same symbols with reference to FIG. 1 and FIG. 2. Detailed descriptions for the same components will be omitted.

In the anode active material layer 22B, for example, by setting the charge capacity of the anode material capable of inserting and extracting lithium to the value smaller than the charge capacity of the cathode 21, lithium metal begins to be precipitated on the anode 22 when the open circuit voltage (that is, battery voltage) is lower than the overcharge voltage during the charge. Therefore, in the secondary battery, both the anode material capable of inserting and extracting lithium and lithium metal function as an anode active material, and the anode material capable of inserting and extracting lithium is a base material when the lithium metal is precipitated. As an anode material capable of inserting and extracting lithium, materials similar to those of the first embodiment can be cited.

The overcharge voltage means the open circuit voltage when the battery becomes in an overcharge state. For example, the overcharge voltage means a higher voltage than the open circuit voltage of the battery, which is “fully charged,” described in and defined by “Guideline for safety assessment of lithium secondary batteries” (SBA G1101), which is one of the guidelines specified by Japan Storage Battery industries Incorporated (Battery Association of Japan). In other words, the overcharge voltage means a higher voltage than the open circuit voltage after charge by using the charge method used in obtaining nominal capacities of each battery, the standard charge method, or a recommended charge method.

Thereby, in the secondary battery, a high energy density can be obtained, and improvement of the cycle characteristics and the rapid charge characteristics that has been a challenging issue in the existing lithium metal secondary batteries can be attained. The secondary battery is similar to the existing lithium ion secondary batteries in terms of using the anode material capable of inserting and extracting lithium for the anode 22. Further, the secondary battery is similar to the existing lithium metal secondary batteries in that lithium metal is precipitated on the anode 22.

To more effectively obtain the foregoing characteristics, for example, the maximum precipitation capacity of lithium metal precipitated on the anode 22 at the time of the maximum voltage before the open circuit voltage becomes the overcharge voltage is preferably from 0.05 times to 3.0 times of the charge capacity ability of the anode material capable of inserting and extracting lithium. When the precipitation amount of lithium metal is excessively high, problems similar to those of the existing lithium metal secondary batteries are caused. Meanwhile, when the precipitation amount of lithium metal is excessively low, the charge and discharge capacity is not able to be sufficiently improved. Further, for example, the discharge capacity ability of the anode material capable of inserting and extracting lithium is preferably 150 mAh/g or more. The higher the ability to insert and extract lithium is, the relatively smaller the precipitation amount of lithium metal becomes. The charge capacity ability of the anode material is obtained by the electric quantity when discharge is performed by constant current and constant voltage method to 0 V for the electrochemical cell in which lithium metal is used as the anode and an anode material capable of inserting and extracting lithium is used as a cathode active material. The discharge capacity ability of the anode material is obtained, for example, by the electric quantity when charge is performed to 2.5 V for 10 hours or more by constant current method subsequently after the foregoing discharge.

In the secondary battery, when charged, lithium ions are extracted from the cathode 21, and firstly inserted in the anode material capable of inserting and extracting lithium contained in the anode 22 through the electrolytic solution. When further charged, in a state that the open circuit voltage is lower than the overcharge voltage, lithium metal begins to be precipitated on the surface of the anode material capable of inserting and extracting lithium. After that, until charge is completed, lithium metal continues to be precipitated on the anode 22. Next, when discharged, first, lithium metal precipitated on the anode 22 is eluted as ions, which are inserted in the cathode 21 through the electrolytic solution. When further discharged, lithium ions inserted in the anode material capable of inserting and extracting lithium in the anode 22 are extracted, and inserted in the cathode 21 through the electrolytic solution. In this embodiment, the electrolytic solution contains the vinylene carbonate and the γ-butyrolactone derivative in which an aryl group is bonded to γ position. Therefore, the decomposition reaction of the solvent is suppressed.

### EXAMPLES

Further, specific examples of the invention will be described in detail.

### Examples 1-1 and 1-2

Batteries in which the anode capacity was expressed by the capacity component due to insertion and extraction of lithium, that is, so-called lithium ion secondary batteries were fabricated.

First, lithium cobaltate (LiCoO₂) as a cathode active material, graphite as an electrical conductor, polyvinylidene fluoride as a binder were mixed to prepare a cathode mixture. The cathode mixture was dispersed in N-methyl-2-pyrrolidone as a solvent to obtain cathode mixture slurry. After that, the cathode current collector 21A made of an aluminum foil was uniformly coated with the cathode mixture slurry, which was dried and compression-molded by a rolling press machine to form the cathode active material layer 21B. Next, the cathode current collector 21A formed with the cathode active material layer 21B was cut in a strip shape of sized 50 mm×350 mm to form the cathode 21. After that, the cathode lead 11 was attached to the cathode current collector 21A.

Further, artificial graphite as an anode active material and polyvinylidene fluoride as a binder were mixed to prepare an anode mixture. The anode mixture was dispersed in N-methyl-2-pyrrolidone as a solvent to obtain anode mixture slurry. After that, the anode current collector 22A made of a copper foil was uniformly coated with the anode mixture slurry, which was dried and compression-molded by a rolling press machine to form the anode active material layer 22B. Next, the anode current collector 22A formed with the anode active material layer 22B was cut in a strip shape of sized 52 mm×370 mm to form the anode 22. The capacity ratio between the cathode 21 and the anode 22 was designed so that the capacity of the anode 22 was expressed by the capacity component due to insertion and extraction of lithium. After that, the anode lead 12 was attached to the anode current collector 22A.

Subsequently, an electrolytic solution was prepared as follows. LiPF₆ as an electrolyte salt was dissolved in a solvent in which ethylene carbonate and propylene carbonate as a solvent were mixed at a weight ratio of ethylene carbonate:propylene carbonate=6:4. Further, additives were mixed therein to prepare an electrolytic solution. The concentration of LiPF₆ was set as 0.7 mol/kg. As the additives, vinylene carbonate and γ-phenyl-γ-butyrolactone or γ-naphthyl-γ-butyrolactone as a γ-butyrolactone derivative in which an aryl group was bonded to γ position were used. The content of vinylene carbonate in the electrolytic solution was 1 wt %, and the content of the γ-butyrolactone derivative in the electrolytic solution was 0.5 wt %.

Next, the obtained electrolytic solution was held by a copolymer of hexafluoropropylene and vinylidene fluoride as a polymer compound. Thereby, the gelatinous electrolyte layer 24 was respectively formed on the cathode 21 and the anode 22. The ratio of hexafluoropropylene in the copolymer was 6.9 wt %.

After that, the cathode 21 and the anode 22 both formed with the electrolyte layer 24 were layered with the separator 23 made of a polyethylene film being 20 μm thick in between and spirally wound to form the spirally wound electrode body 20.

The obtained spirally wound electrode body 20 was sandwiched between the package member 31 made of a laminated film, and inserted therein under the reduced pressure. Thereby, the secondary battery shown in FIG. 1 and FIG. 2 was fabricated.

As Comparative example 1-1 relative to Examples 1-1 and 1-2, a secondary battery was fabricated in the same manner as in Examples 1-1 and 1-2, except that only vinylene carbonate was used as an additive. Further, as Comparative examples 1-2 and 1-3, secondary batteries were fabricated in the same manner as in Examples 1-1 and 1-2, except that only γ-phenyl-γ-butyrolactone was used as an additive or only γ-naphthyl-γ-butyrolactone was used as an additive. In Comparative example 1-1, the content of vinylene carbonate in the electrolytic solution was 1 wt %. In Comparative examples 1-2 and 1-3, the content of the γ-butyrolactone derivative in the electrolytic solution was 0.5 wt %.

For the fabricated secondary batteries of Examples 1-1 and 1-2 and Comparative examples 1-1 to 1-3, the initial efficiency was examined as follows. First, constant current and constant voltage charge of 0.1C was performed at 23 deg C. until the upper limit of 4.2 V for 12 hours as the total charge time. Subsequently, constant current discharge of 0.2 C was performed at 23 deg C. until the final voltage of 3.0 V. The initial efficiency was obtained based on the retention ratio of the discharge capacity to the charge capacity at that time, that is, (discharge capacity/charge capacity)×100(%). 0.1 C and 0.2 C are the current values at which the theoretical capacity is completely discharged in 10 hours and 5 hours, respectively. The results are shown in Table 1.

Further, high-temperature charge storage characteristics were examined as follows. First, constant current and constant voltage charge of 1 C was performed at 23 deg C. until the upper limit of 4.2 V for 3 hours as total charge time. After that, the secondary batteries were stored for 2 weeks at 70 deg C. The high-temperature charge storage characteristics were obtained based on the battery swollenness amount after stored, that is, (battery thickness after stored)/battery thickness before stored). 1 C is the current value at which the theoretical capacity is completely discharged in 1 hour. The results are shown in Table 1.

TABLE 1

| | | Initial | |
|---|---|---|---|
| | | efficiency | Swollenness |
| | Additive | (%) | ratio (mm) |
| Example 1-1 | γ-phenyl-γ-butyrolactone + | 92.0 | 0.01 |
| | vinylene carbonate | | |
| Example 1-2 | γ-naphthyl-γ-butyrolactone + | 91.4 | 0.04 |
| | vinylene carbonate | | |
| Comparative | Vinylene carbonate | 88.4 | 0.55 |
| example 1-1 | | | |
| Comparative | γ-phenyl-γ-butyrolactone | 88.0 | 0.01 |
| example 1-2 | | | |
| Comparative | γ-naphthyl-γ-butyrolactone | 87.7 | 0.03 |
| example 1-3 | | | |

As evidenced by Table 1, according to Examples 1-1 and 1-2 using vinylene carbonate and γ-phenyl-γ-butyrolactone or γ-naphthyl-γ-butyrolactone as a γ-butyrolactone derivative as an additive, the initial efficiency was higher than in Comparative examples 1-2 and 1-3 not using vinylene carbonate, and the battery swollenness amount was smaller and the initial efficiency value was higher than in Comparative example 1-1 not using the γ-butyrolactone derivative.

That is, it was found that when the electrolytic solution contained the vinylene carbonate and the γ-butyrolactone derivative in which an aryl group is bonded to γ position, the battery swollenness could be prevented while the initial efficiency could be improved.

### Examples 2-1 to 2-6 and 3-1 to 3-6

Secondary batteries were fabricated in the same manner as in Example 1-1 or Example 1-2, except that the content of the γ-butyrolactone derivative in the electrolytic solution was changed in the range from 0.05 wt % or more to 3 wt % or less as shown in Tables 2 and 3. For the fabricated secondary batteries, the initial efficiency was examined in the same manner as in Examples 1-1 and 1-2. The results are shown in Tables 2 and 3 together with the results of Examples 1-1 and 1-2 and Comparative example 1-1.

TABLE 2

| | Additive | | | | Initial |
|---|---|---|---|---|---|
| | | Content | | Content | efficiency |
| | Kind | (wt %) | Kind | (wt %) | (%) |
| Example 2-1 | γ-phenyl-γ- | 3 | Vinylene | 1 | 89.6 |
| Example 2-2 | butyrolactone | 2 | carbonate | 1 | 90.5 |
| Example 2-3 | | 1 | | 1 | 91.4 |
| Example 1-1 | | 0.5 | | 1 | 92.0 |
| Example 2-4 | | 0.25 | | 1 | 91.8 |
| Example 2-5 | | 0.1 | | 1 | 90.3 |
| Example 2-6 | | 0.05 | | 1 | 89.2 |
| Comparative | γ-phenyl-γ- | 0 | Vinylene | 1 | 88.4 |
| example 1-1 | butyrolactone | | carbonate | | |

TABLE 3

| | Additive | | | | Initial |
|---|---|---|---|---|---|
| | | Content | | Content | efficiency |
| | Kind | (wt %) | Kind | (wt %) | (%) |
| Example 3-1 | γ-naphthyl-γ- | 3 | Vinylene | 1 | 89.7 |
| Example 3-2 | butyrolactone | 2 | carbonate | 1 | 90.6 |
| Example 3-3 | | 1 | | 1 | 91.7 |
| Example 1-2 | | 0.5 | | 1 | 91.4 |
| Example 3-4 | | 0.25 | | 1 | 90.7 |
| Example 3-5 | | 0.1 | | 1 | 90.1 |
| Example 3-6 | | 0.05 | | 1 | 88.8 |
| Comparative | γ-naphthyl-γ- | 0 | Vinylene | 1 | 88.4 |
| example 1-1 | butyrolactone | | carbonate | | |

As evidenced by Tables 2 and 3, as the content of the γ-butyrolactone derivative in the electrolytic solution was increased, the initial efficiency was increased, showed the maximum value, and then decreased.

That is, it was found that the content of the γ-butyrolactone derivative in which an aryl group was bonded to γ position in the electrolytic solution was preferably in the range from 0.1 wt % or more to 2 wt % or less.

### Examples 4-1 to 4-4 and 5-1 to 5-4

Secondary batteries were fabricated in the same manner as in Example 1-1 or Example 1-2, except that the content of vinylene carbonate in the electrolytic solution was changed in the range from 0.2 wt % or more to 3 wt % or less as shown in Tables 4 and 5. The content of the γ-butyrolactone derivative in the electrolytic solution was 1 wt %. For the fabricated secondary batteries, the initial efficiency was examined in the same manner as in Examples 1-1 and 1-2. The results are shown in Tables 4 and 5 together with the results of Examples 2-3 and 3-3.

TABLE 4

| | Additive | | | | Initial |
|---|---|---|---|---|---|
| | | Content | | Content | efficiency |
| | Kind | (wt %) | Kind | (wt %) | (%) |
| Example 4-1 | γ-phenyl-γ- | 1 | Vinylene | 3 | 91.4 |
| Example 4-2 | butyrolactone | 1 | carbonate | 2 | 91.9 |
| Example 2-3 | | 1 | | 1 | 91.4 |
| Example 4-3 | | 1 | | 0.5 | 91.0 |
| Example 4-4 | | 1 | | 0.2 | 89.6 |

TABLE 5

| | Additive | | | | Initial |
|---|---|---|---|---|---|
| | | Content | | Content | efficiency |
| | Kind | (wt %) | Kind | (wt %) | (%) |
| Example 5-1 | γ-naphthyl-γ- | 1 | Vinylene | 3 | 91.3 |
| Example 5-2 | butyrolactone | 1 | carbonate | 2 | 91.3 |
| Example 3-3 | | 1 | | 1 | 91.7 |
| Example 5-3 | | 1 | | 0.5 | 90.8 |
| Example 5-4 | | 1 | | 0.2 | 89.3 |

As evidenced by Tables 4 and 5, the initial efficiency showed particularly high values in Examples 2-3, 4-1 to 4-3, or Examples 3-3, 5-1 to 5-3 in which the content of vinylene carbonate in the electrolytic solution was 0.5 wt % or more.

That is, it was found that the content of vinylene carbonate in the electrolytic solution was preferably 0.5 wt % or more.

The invention has been described with reference to the embodiments and the examples. However, the invention is not limited to the foregoing embodiments and the foregoing examples, and various modifications may be made. For example, in the foregoing embodiments and the foregoing examples, the descriptions have been given of the specific example of the secondary battery having the spirally wound structure. However, the invention can be similarly applied to a secondary battery having a structure in which a cathode and an anode are folded or a secondary battery having other lamination structure in which a cathode and an anode are layered.

Further, in the foregoing embodiments and the foregoing examples, the descriptions have been given of the case using lithium as an electrode reactant. However, the invention can be also applied to the case using other element in Group 1 in the long period periodic table such as sodium (Na) and potassium (K); other element in Group 2 in the long period periodic table such as magnesium and calcium (Ca); other light metal such as aluminum; or an alloy of lithium or the foregoing element. In that case, similar effects can be also obtained. The cathode active material capable of inserting and extracting the electrode reactant, a solvent or the like can be selected according to the electrode reactant.

Further, in the foregoing embodiments and the foregoing examples, descriptions have been given of the case using the gelatinous electrolyte in which the electrolytic solution is held in the polymer compound. However, other electrolyte may be used instead of the foregoing electrolyte. As other electrolyte, for example, an electrolyte including only a liquid electrolytic solution, a mixture of a solid electrolyte having ion conductivity and an electrolytic solution, or a mixture of a solid electrolyte and a gelatinous electrolyte can be cited.

As a solid electrolyte, for example, a polymer solid electrolyte in which an electrolyte salt is dispersed in a polymer compound having ion conductivity, or an inorganic solid electrolyte composed of ion conductive glass, ionic crystal or the like can be used. As a polymer compound, for example, an ether polymer compound such as polyethylene oxide and a cross-linked body containing polyethylene oxide, or an ester polymer compound such as poly methacrylate and poly acrylate can be used singly, by mixing, or by copolymerization in the molecule. As an inorganic solid electrolyte, lithium nitride, lithium iodide or the like can be used.

Further, in the foregoing embodiments and the foregoing examples, descriptions have been given of the case using a film for the package member 31. However, the invention can be applied to secondary batteries having other shape such as a cylinder, a square, a coin, and a button that use a metal container for the package member. In that case, similar effects can be obtained. In addition, the invention can be applied to primary batteries in addition to the secondary batteries.

1. An electrolytic solution containing vinylene carbonate and a γ-butyrolactone derivative in which an aryl group is bonded to γ position.

2. The electrolytic solution according to claim 1, wherein a content of the vinylene carbonate is 0.5 wt % or more.

3. The electrolytic solution according to claim 1, wherein a content of the γ-butyrolactone derivative is in a range from 0.1 wt % or more to 2 wt % or less.

4. The electrolytic solution according to claim 1 further containing propylene carbonate.

5. A battery comprising:
a cathode;
an anode; and
an electrolytic solution,
wherein the electrolytic solution contains vinylene carbonate and a γ-butyrolactone derivative in which an aryl group is bonded to γ position.

6. The battery according to claim 5, wherein a content of the vinylene carbonate in the electrolytic solution is 0.5 wt % or more.

7. The battery according to claim 5, wherein a content of the γ-butyrolactone derivative in the electrolytic solution is in a range from 0.1 wt % or more to 2 wt % or less.

8. The battery according to claim 5, wherein the electrolytic solution further contains propylene carbonate.
